(19) United States
(12) Patent Application Publication
(10) Pub. No.: US 2002/0097808 A1
(43) Pub. Date: Jul. 25, 2002

(54) Digitally-controlled line build-out circuit

(75) Inventors: Roubik Gregorian, Saratoga, CA (US); Shin-Chung Fan, Fremont, CA (US)

Correspondence Address: Paul C. Haughey, TOWNSEND and TOWNSEND and CREW LLP, 8th Floor, Two Embarcadero Center, San Francisco, CA, 94111-3834, US

(73) Assignee: Exar Corporation

(21) Appl. No.: 09/728,301

(22) Filed: Dec. 1, 2000

(51) Int. Cl. H04L 27/04; H04L 27/12

(52) U.S. Cl. 375/295

(57) ABSTRACT

A digital LBO in which digitized versions of the desired waveforms are stored in memory. A selection circuit allows the selection of certain ones of said waveforms corresponding to an anticipated amount of signal degradation over a transmission line. A digital-to-analog converter converts those certain waveforms into analog waveforms for transmission.

### BACKGROUND OF THE INVENTION

The present invention relates to line build-out (LBO) circuits, and in particular to a digital LBO.

When signals are transmitted over a transmission line, they will degrade with distance depending upon the impedance of the transmission line and the interference received. In particular, higher frequencies typically will degrade and spread more than lower frequency portions of a signal. Thus, when a digital one is transmitted as a clean, rectangular pulse, it may be received as a rounded, spread out pulse. The pulses can typically be reconstructed at the receiver, and restored to their clean form, using an equalizer and other circuitry.

However, when pulses are received from multiple transmission lines having traveled different distances or over different impedance lines, the amount of degradation of each pulse may vary. Accordingly, one technique used to compensate for this is to use an LBO at the transmitter to effectively pre-distort the signal sent over the shorter or less impedance transmission lines so that, upon receipt by the receiver or a repeater, they will have an equal amount of degradation to pulses sent over the longer or higher impedance transmission lines. Typically, an LBO has multiple settings for four different signal levels corresponding to different levels of degradation. These are 0, 7.5, 15 or 22 dB. Typically, the LBO is an analog circuit, such as a resistor-capacitor (RC) combination, or more complicated circuitry. Examples of analog LBOs are set forth, for example, in U.S. Pat. Nos. 4,785,265 and 4,964,116.

### SUMMARY OF THE INVENTION

The present invention provides a digital LBO in which digitized versions of the desired waveforms are stored in memory. A selection circuit allows the selection of certain ones of said waveforms corresponding to an anticipated amount of signal degradation over a transmission line. A digital-to-analog converter converts those certain waveforms into analog waveforms for transmission.

In a preferred embodiment, digitized waveforms are provided for multiple levels of degradation (i.e., 7.5, 15 or 22 dB). For each of those digitized waveforms, multiple, separately addressable portions are provided. Since the degradation of a waveform causes it to overlap with adjacent waveforms, the digitized waveforms are combined to include the overlap portions of the previous waveforms. The output data is delayed multiple times to provide different selection signals (1 or 0) to a gating circuit which provides the appropriate pulse portion (or inhibits it for a 0) to digital adders. The output of the adders are provided to a digital-to-analog converter (DAC) to provide the combined output signal.

For a further understanding of the nature and advantages of the invention, reference should be made to the following description taken in conjunction with the accompanying drawings.

### BRIEF DESCRIPTION OF THE DRAWINGS

FIG. 1 is a block diagram of a digital line build-out circuit according to an embodiment of the invention.

FIG. 2 is a diagram of more detail of an embodiment of a ROM circuit for a quarter of a pulse in FIG. 1.

FIG. 3 is a timing diagram illustrating the combination of multiple waveforms according to the circuit of FIG. 1.

### DESCRIPTION OF THE SPECIFIC EMBODIMENTS

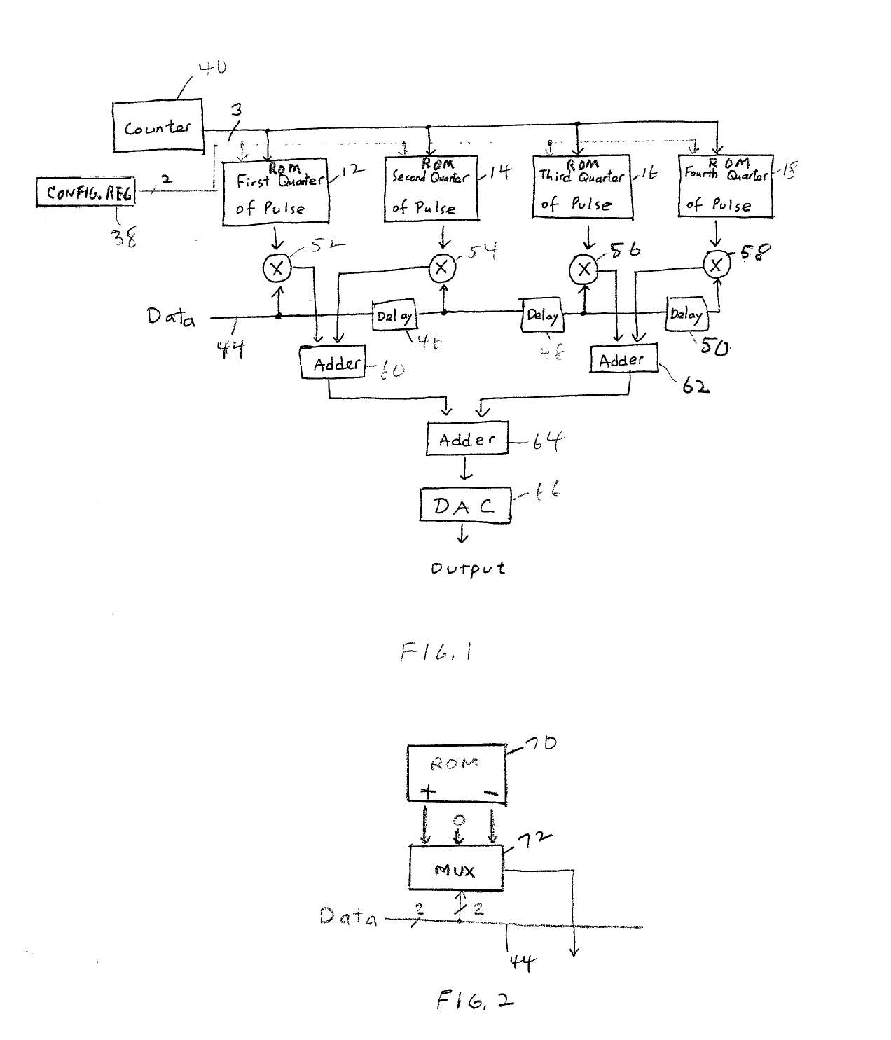

FIG. 1 shows four read only memories (ROM) 12, 14, 16 and 18. Alternately, these may be four portions of a single ROM, or a programmable ROM (PROM) or other memory. The four portions correspond to portions of an example waveform 20 as illustrated in FIG. 3. Waveform 20 has a first portion 22, a second portion 24, a third portion 26, and a fourth portion 28 in time periods 1, 2, 3 and 4, respectively.

FIG. 1 shows an example of the operation of the invention for a particular combination of bits. A second bit of zero produces no pulse, and thus a zero value waveform 30 is generated. A third data bit is a one, generating a waveform having portions 32, 33, 34 and 35. This third data bit is inverted in one embodiment where a Bipolar Alternate Mark Inversion method is used, as described below. A fourth bit is also a one, generating a fourth waveform having portions 36, 37, 38 and 39.

As can be seen, in time period one, only the portion of pulse 22 is provided. In a second time period, the pulse portion 24 is combined with the zero value of pulse 30. In the third time period, the pulse portion 26 is combined with the zero level of waveform 30 as well as the portion 32 of a pulse corresponding to the subsequent one bit. Finally, in time period 4, portion 28 is combined with portion 33 of the second one bit's pulse, and portion 36 of the third one bit's pulse.

All the one pulses used in FIG. 3 would be identical (or inverted), but skewed in time, and correspond to a particular amount of dB of degradation. Referring back to FIG. 1, the four ROMs 12-18 would contain the four portions 22, 24, 26 and 28 of a pulse. The particular pulse used is selected by a configuration register 38 which provides two bits to the different ROMs, selecting a pulse corresponding to the appropriate amount of dB of degradation. Each of the possible selections has four different quarters or portions which are stored in the different ROMs.

A counter 40 sequentially selects, according to the sampling rates, the different samples of each portion of the pulse. Referring again to FIG. 3, in one embodiment, this comprises eight samples indicated by lines 40.

The data bits themselves (1011 in the example of FIG. 3) are provided on a line 44 in FIG. 1. Each of the bits is delayed by delay elements 46, 48 and 50. The data bits and the three previous delayed data bits are provided to selection circuits 52, 54, 56 and 58. The selection circuits are indicated as multipliers, wherein the data bit can be multiplied by the output to either allow it to pass or provide a zero value. If the data is a zero, the multiplier will negate the pulse output, giving a zero waveform 30 as shown in FIG. 3. If the data bit is a one, it simply allows the digitized pulse to pass through to the output of the selection circuit. As known by those of skill in the art, such a multiplier circuit can be implemented as a simple gate with the data bit providing a control input. The delays correspond to the width of a pulse, which also correspond to counter 40 sequentially counting through eight bits, before repeating for the next pulse portion.

The outputs of the selection circuits are provided to adders 60 and 62, which each combine two waveforms. The outputs of the two adders are provided to a third adder 64, to produce a composite of the four digitized waveforms. This composite is then presented to a digital-to-analog converter (DAC) 66. The output is then provided to the transmission line.

As can be seen, this digitally controlled LBO synthesizes the waveform directly, rather than passing the data bits through an analog circuit as in the prior art. This eliminates the need to provide a resistor and capacitor on a chip to provide an LBO circuit. Instead, the outcome will be entirely generated in digital form and then provided to a DAC.

In the embodiment used for T1/E1, the transmission is +V, 0 and −V, using Bipolar Alternate Mark Inversion. Each symbol is represented by two bits:

| TP | TN | Output |
|---|---|---|
| 0 | 0 | 0 |
| 1 | 0 | +V |
| 0 | 1 | −V |

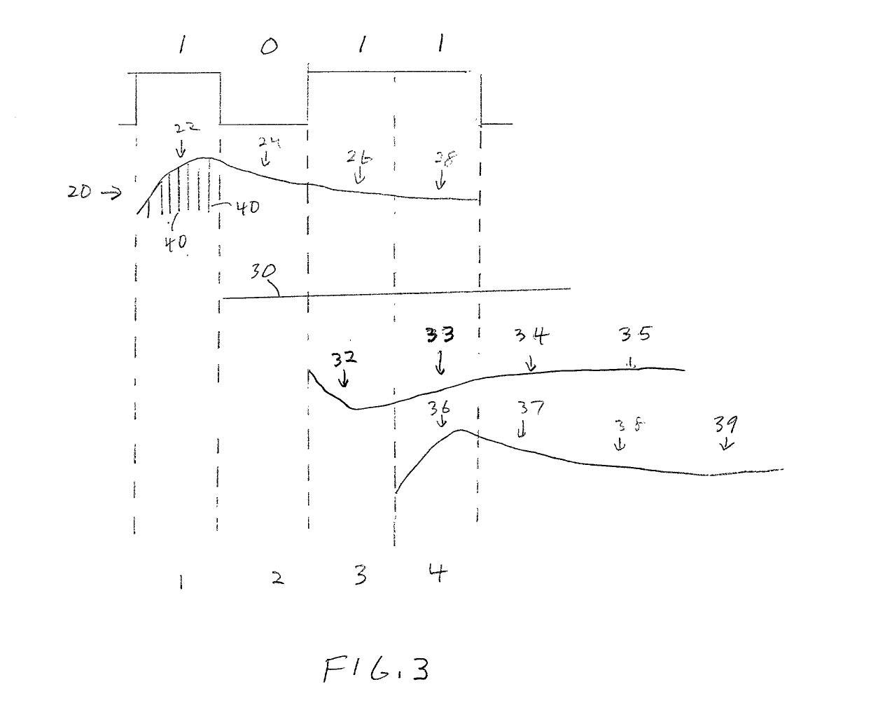

In this embodiment, the ROMs actually store both the positive and the negative of the waveform. FIG. 2 illustrates one of the ROMs of FIG. 1 in more detail to show this embodiment. In particular, ROM 70 in FIG. 2 provides both a positive and a negative output. A multiplexer 72 selects either the negative or positive waveform, or a 0 input. The data on line 44 is thus 2 bits wide in this embodiment.

As will be understood by those of skill in the art, the present invention may be embodied in other specific forms without departing from the essential characteristics thereof. For example, either four ROMs could be used, or a single ROM or other memory with multiple locations storing the different portions of a pulse. The delay circuit can be implemented in any number of ways, such as by a shift register which is clocked each time the counter rolls over. Instead of using a configuration register, select lines could be provided to the output of a chip, or PROM fuses or other selection devices could be used.

Accordingly, the foregoing description is intended to be illustrative, but not limiting, of the scope of the invention which is set forth in the following claims.

What is claimed is:

1. A digital line build out circuit comprising:
a memory storing a plurality of digitized waveforms;
a selection circuit, coupled to said memory, to select certain ones of said waveforms corresponding to an anticipated amount of signal degradation over a transmission line; and
a digital to analog converter to convert said certain ones of said waveforms into analog waveforms for transmission.

2. The circuit of claim 1 further comprising:
a counter having an output coupled to inputs of said memory for sequentially selecting multiple samples of said digitized waveforms during a period.

3. The circuit of claim 1 wherein said memory comprises a ROM.

4. The circuit of claim 1 further comprising:
a combining circuit, coupled between said memory and said digital to analog converter, to combine a portion of a current digitized waveform with a portion of at least one previous digitized waveform.

5. The circuit of claim 4 wherein said combining circuit includes at least one delay element for delaying an output of said memory for said previous digitized waveform for combination with said current digitized waveform.

6. The circuit of claim 5 wherein said delay element delays a data bit, and further comprising a circuit for gating a portion of said digitized waveform from said memory based on a value of said data bit.

7. The circuit of claim 4 wherein said combining circuit combines portion of a current waveform with portions of three previous waveforms.

8. A digital line build out circuit comprising:
a memory storing a plurality of digitized waveforms;
a selection circuit, coupled to said memory, to select certain ones of said waveforms corresponding to an anticipated amount of signal degradation over a transmission line;
a digital to analog converter to convert said certain ones of said waveforms into analog waveforms for transmission;
a counter having an output coupled to inputs of said memory for sequentially selecting multiple samples of said digitized waveforms during a period; and
a combining circuit, coupled between said memory and said digital to analog converter, to combine a portion of a current digitized waveform with a portion of at least one previous digitized waveform.

9. A digital line build out circuit comprising:
a memory storing a plurality of digitized waveforms corresponding to different anticipated amounts of signal degradation over a transmission line, each of said digitized waveforms having a plurality of separately addressable portions;
a data line coupled to a plurality of serial delay elements;
a plurality of gating circuits having a first input coupled to one of said data line and an output of each of said delay elements, and a second input coupled to an output of said memory for one of said separately addressable portions;
a combining circuit having inputs coupled to outputs of said gating circuits for combining multiple ones of said separately addressable portions;
a digital to analog converter coupled to an output of said combining circuit;
a configuration input, coupled to said memory, for selecting a desired one of said plurality of digitized waveforms; and
a counter, coupled to said memory, for sequentially selecting a plurality of digitized values for said separately addressable portions.

10. The circuit of claim 9 wherein said memory is a ROM.

11. The circuit of claim 9 wherein said memory comprises a plurality of memories.

12. The circuit of claim 9 where said gating circuits comprise a multiplier circuits.

13. The circuit of claim 9 wherein said gating circuits comprise selector circuits.
